(19) United States
(12) Patent Application Publication
(10) Pub. No.: US 2008/0115804 A1
(43) Pub. Date: May 22, 2008

(54) Settling tank wall scraper and method

(76) Inventor: James I. Hall, Linden, VA (US)

Correspondence Address: BUCHANAN, INGERSOLL & ROONEY PC, POST OFFICE BOX 1404, ALEXANDRIA, VA, 22313-1404, US

(21) Appl. No.: 11/979,702

(22) Filed: Nov. 7, 2007

Related U.S. Application Data
(60) Provisional application No. 60/859,516, filed on Nov. 17, 2006.

(51) Int. Cl. B08B 9/087

(52) U.S. Cl. 134/6; 15/93.1

(57) ABSTRACT

A device for scraping a wall of a settling tank includes a mobile carrier having opposite ends defining a front-to-rear axis of the carrier, the carrier configured to travel along the top of a wall of a settling tank. At least one scraper blade is carried by the carrier and projects downwardly therefrom. A bottom portion of each of the blades includes a scraping edge facing in a travel direction of the carrier and having a height dimensioned to scrape a band of built-up solids from a surface of the wall.

This application claims priority under 35 U.S.C. §119 and/or 365 to U.S. Provisional Application Ser. No. 60/859,516 filed on Nov. 17, 2006, the entire content of which is hereby incorporated herein.

### BACKGROUND OF THE INVENTION

1. Field of the Invention

The present invention relates to a system and method for build-up removal from wastewater treatment processing tanks, and more particularly, to a system and method for scraping build-up of solids material from walls within wastewater treatment settling tanks.

2. Discussion of the Related Art

The treatment of wastewater typically includes passing wastewater through a settling tank or sediment basin for separating and removing contaminants such as grease, oil, and sediment by gravity. Settling tanks may also be divided into two or more basins to accommodate down time for cleaning or inspecting one basin while allowing one or more basins to continue to function normally without impacting the overall volume of water being treated.

As the sediment accumulates over time, it is necessary to periodically clean the settling tanks to ensure proper operation. To remove accumulated solids, a tank may be drained and the sediment removed. Such costly and time intensive cleaning may typically be done only about once or twice a year.

While the purpose of a settling tank is to allow the collection of sediment at the bottom of the tank, over time solids material may also accumulate along the walls of the tank. The material accumulates along the wall at the water surface, which typically rises and falls a short distance, e.g. 1 to 4 inches, usually about 2 inches. Thus, the material accumulates in the form of a short (e.g. two-inch) band along the tank walls. Each assembly 230 includes a scrape blade 231 extending downwardly from a respective side of the sled assembly 200. To reduce this accumulation and control the unwanted build-up, the walls of a settling tank are frequently cleaned with a scraper to allow the accumulation to break free and reenter the flow of water being treated. The time consuming and laborious work of scraping the walls is generally done by a person walking along the edge of each wall scraping the wall with a scraper blade on a long handle. Settling tank walls are typically ten to twelve feet tall and obviously pose significant risks, such as a fall or physical contact with waste materials, to an individual working along their sides.

These risks are elevated when the person is scraping the center or separation walls between basins, because a separation wall is generally less than a foot wide and can be several hundred feet long.

These and other deficiencies exist with conventional settling tank cleaning methods. Therefore, a solution to these and other problems is needed providing a settling tank scraper specifically designed for ease of use and to minimize the dangers to an operator.

### SUMMARY OF THE INVENTION

One aspect of the invention involves an apparatus for scraping a wall of a settling tank, comprising:

a mobile carrier having opposite ends defining a front-to-rear axis of the carrier, the carrier configured to travel along the top of a wall of a settling tank, and

a scraper blade carried by the carrier and projecting downwardly from one side of the carrier,

wherein a bottom portion of the blade includes a scraping edge facing in a travel direction of the carrier and having a height dimensioned to scrape a band of built-up solids from a surface of the wall.

Another aspect of the invention involves an apparatus for scraping a divider wall of a settling tank, comprising:

a mobile carrier having opposite ends defining a front-to-rear axis of the carrier, the carrier configured to travel along the top of a divider wall of a settling tank; and

first and second scraper blades carried by the carrier and extending downwardly from respective sides of the carrier;

wherein the bottom portions of the first and second scraper blades are biased toward one another during a wall-scraping operation in order to firmly engage respective opposite surfaces of the divider wall for scraping respective bands of built-up solids from such surfaces.

Yet another aspect of the invention relates to a method for scraping a wall of a settling tank comprising the steps of:

moving a carrier along a top of the wall; and

causing the bottom portion of a scraper blade carried by, and extending downwardly from, the carrier to engage a surface of the wall to scrape a band of built-up solids from the surface.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 provides a top view of a typical settling tank with two sediment basins separated by a center wall;

FIG. 2A shows a front view of a settling tank scraper, according to an embodiment of the present invention;

FIG. 2B shows a top view of a settling tank scraper, according to an embodiment of the present invention;

FIG. 2C shows a detailed view of scraper blade assemblies attached to a center support member for a settling tank scraper, according to an embodiment of the present invention;

FIG. 2D shows a blade assembly for a settling tank scraper, according to an embodiment of the present invention;

FIG. 2E shows a side view of a settling tank scraper, according to an embodiment of the present invention; and

FIG. 2F shows a detailed view of a roller and axle configuration for a settling tank scraper, according to an embodiment of the present invention.

FIG. 2G shows a cross-sectional view taken along plane 2G-2G in FIG. 2D.

FIG. 2H is a fragmentary view showing how a scraper blade can be in multiple pieces and vertically adjustable.

### DETAILED DESCRIPTION OF PREFERRED EMBODIMENTS

Reference will now be made in detail to various embodiments of the present invention, examples of which are illustrated in the accompanying drawings.

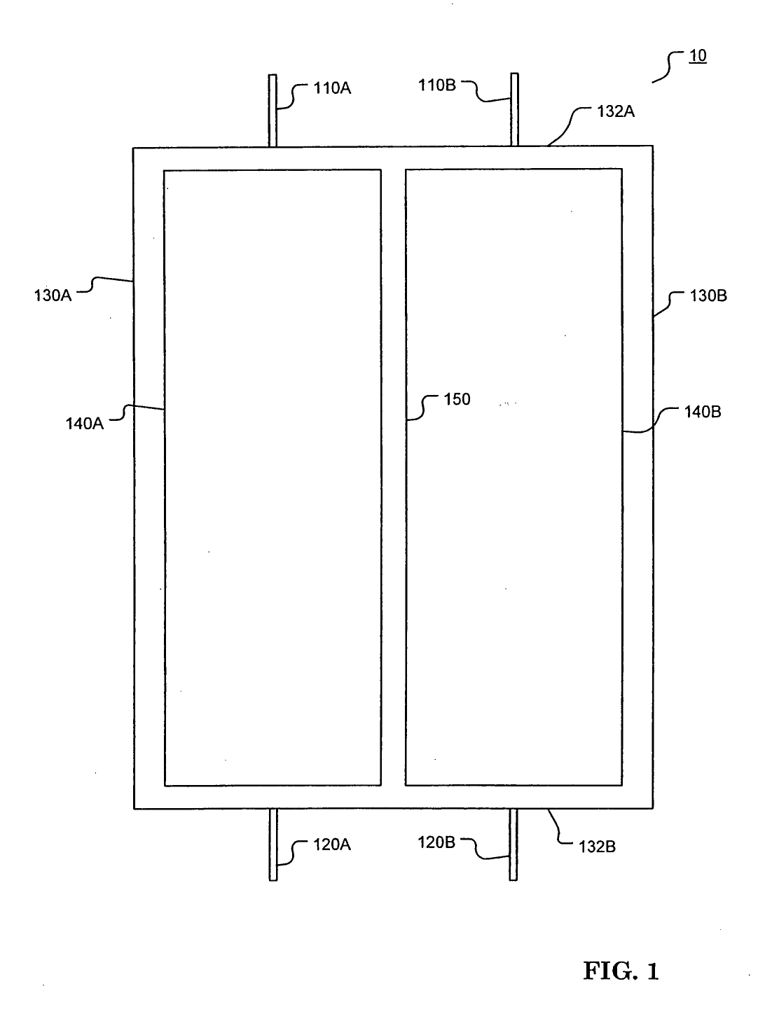

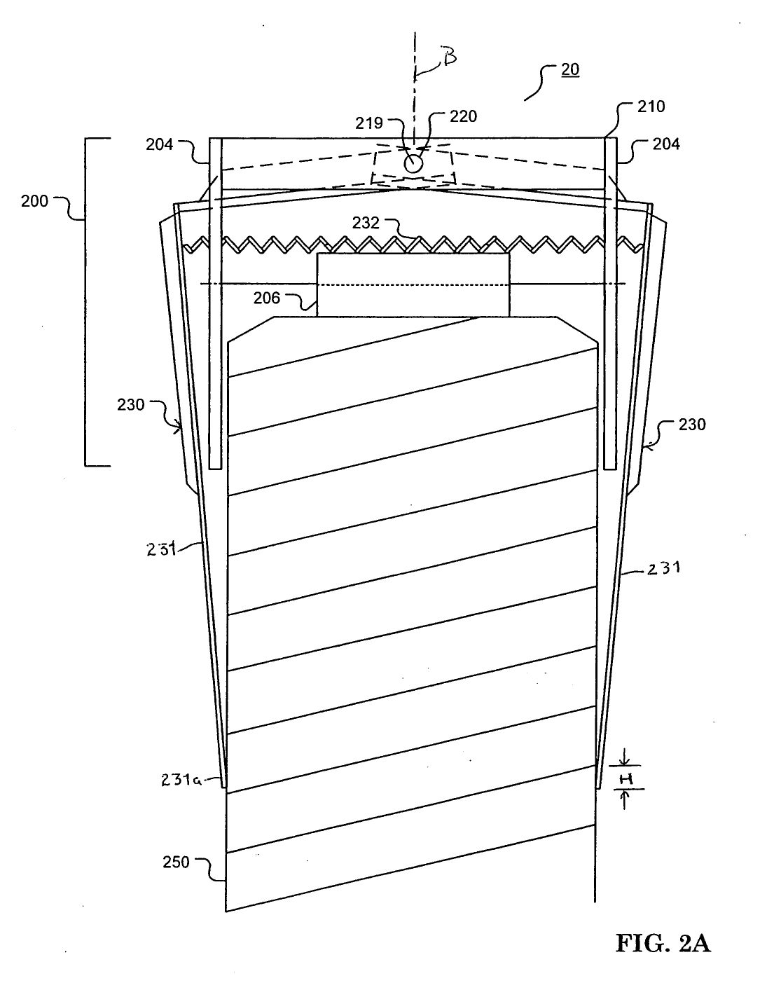

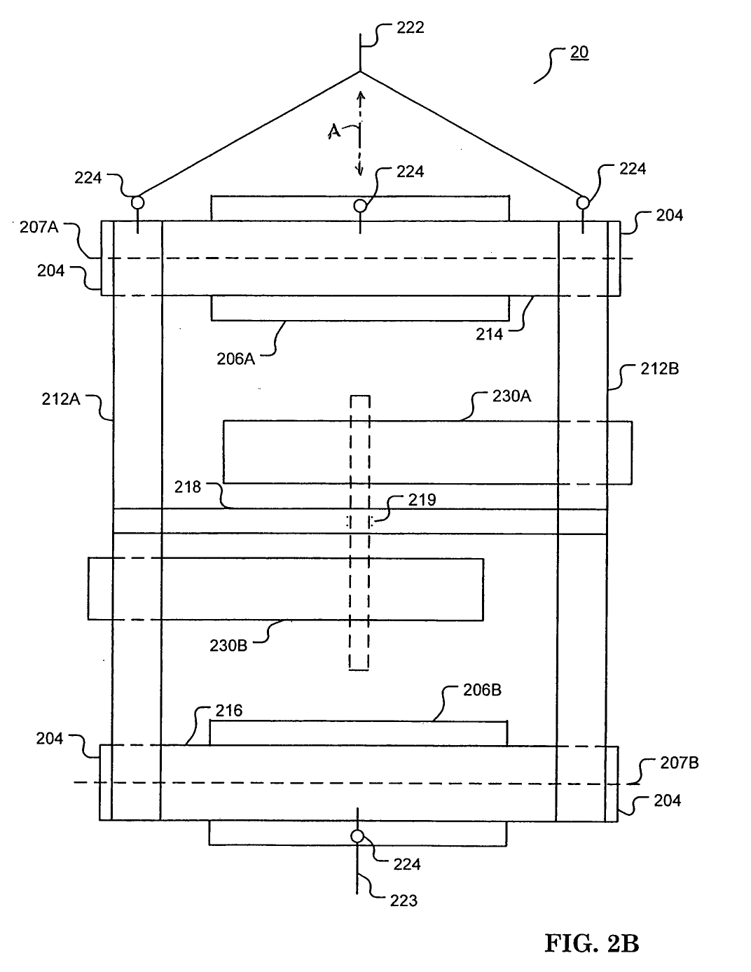

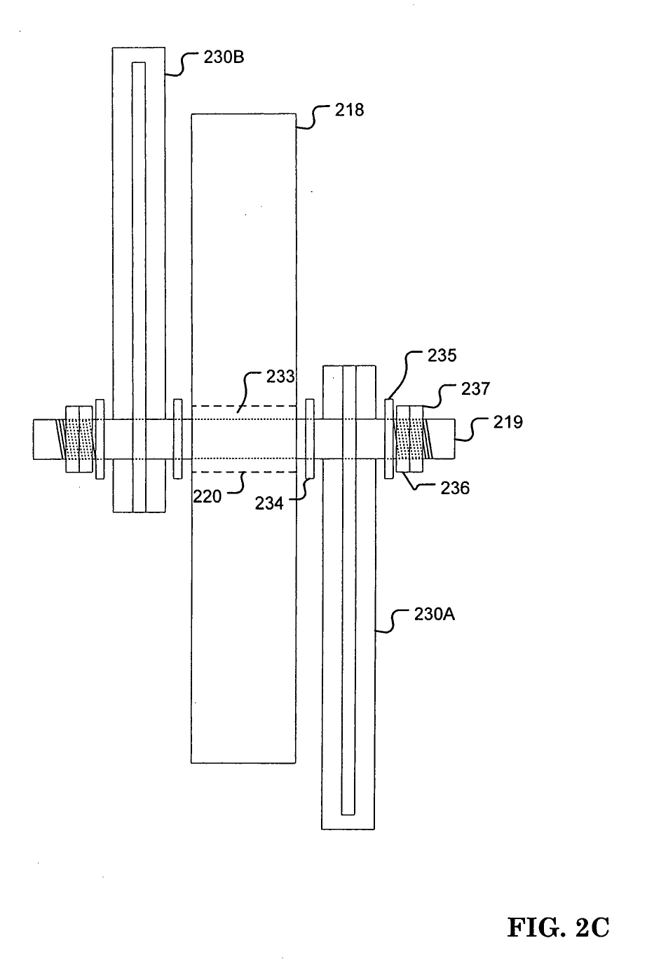

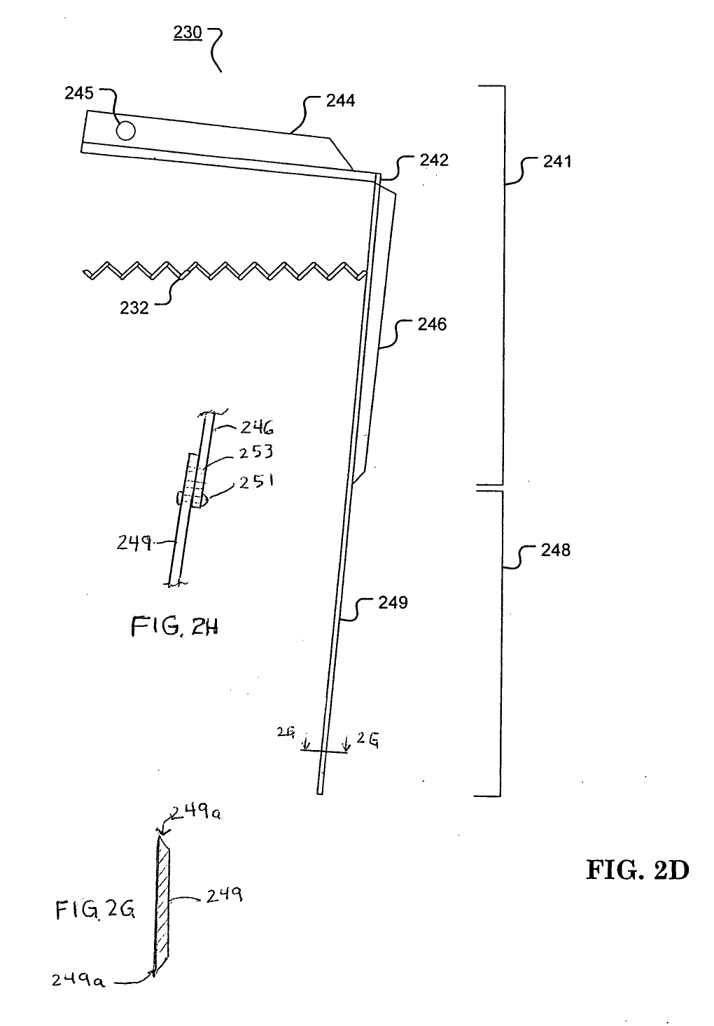

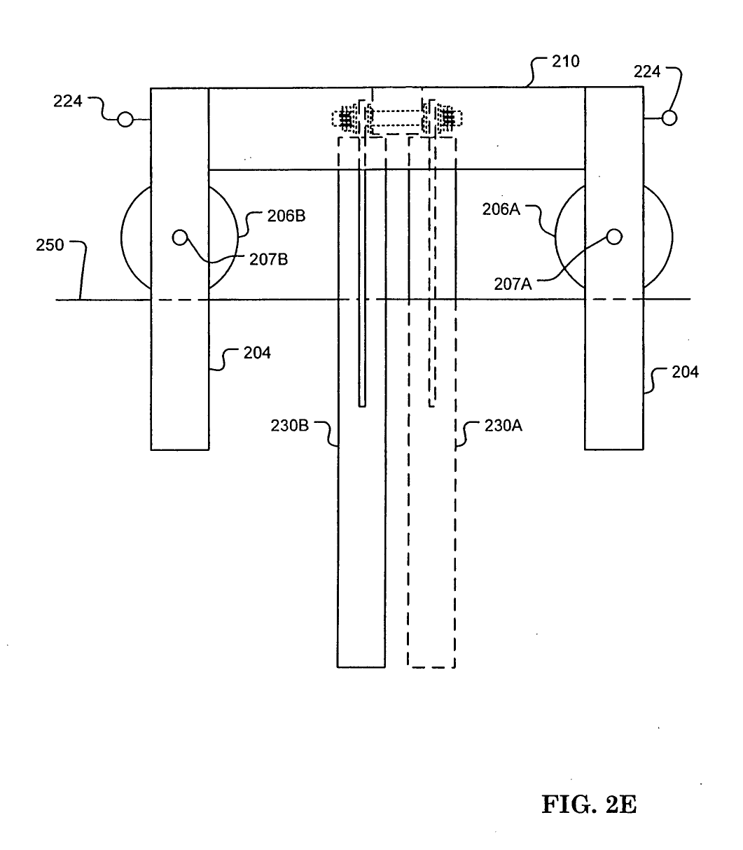

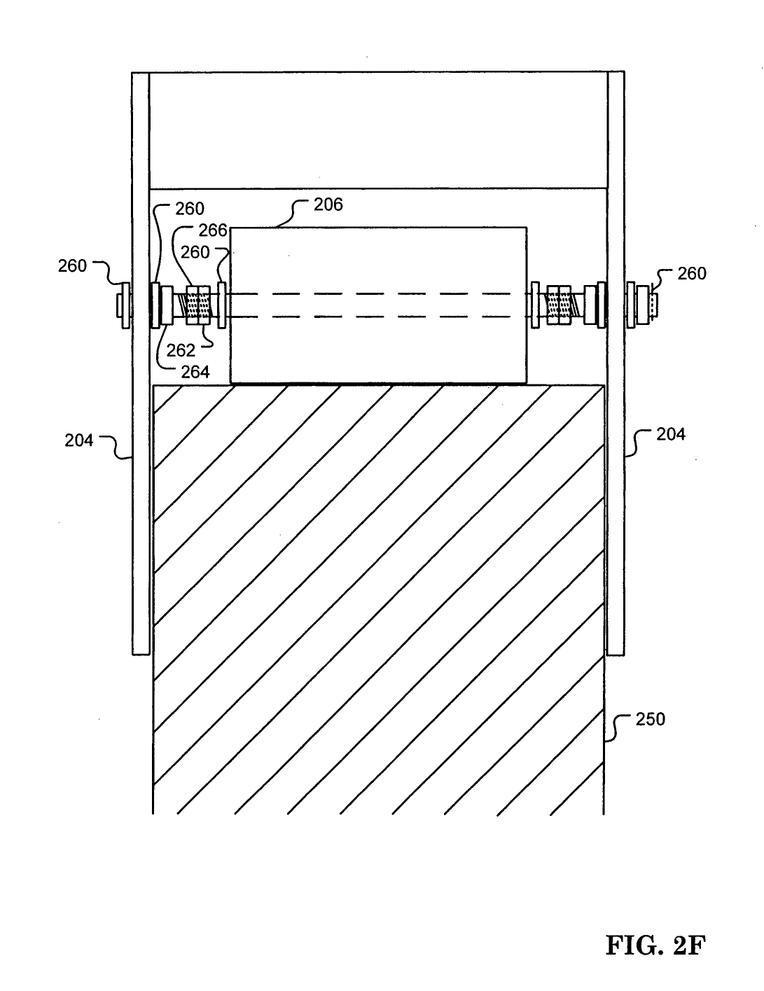

FIG. 1 provides a top view of a settling tank including two sediment basins separated by a center divider wall. A settling tank 10 typically includes a basin formed by side walls 130A and 130B and end walls 132A and 132B in which waste water enters through one or more influent lines 110A and 110B through end wall 132A and exits through one or more effluent lines 120A and 120B through end wall 132B. As the water passes through the basin, sediment and other waste material will separate from the water by dropping to the bottom of the basin. As shown in FIG. 1, settling tank 10 also includes a center or divider wall 150 to create multiple basins 140A and 140B within the settling tank 10. While the sediment and waste products within the wastewater will typically settle to the bottom of the settling tank, build-up also occurs along the walls of the tank. The material accumulates along the wall at the water surface, which typically rises and falls a short distance, e.g. 1 to 4 inches, usually about 2 inches. Thus, the material typically accumulates in the form of a short (e.g. two-inch) band along the tank walls. The height H of such a band is shown in FIG. 2A. The build-up must then be removed on a regular basis to ensure proper operation of the tank.

FIG. 2A shows a front view of a settling tank scraper, according to an embodiment of the present invention. The settling tank scraper 20 shown in FIG. 2 includes a mobile carrier in the form of a sled assembly 200, and one or more scraper blade assemblies 230. The sled assembly 200 travels along the top of a settling tank wall (i.e. a side wall on a divider wall 250) allowing the scraper blade assemblies 230 to scrape along the side surfaces of the wall 250.

The sled assembly 200 shown in FIG. 2A includes a support frame assembly 210, one or more guides 204, and one or more floor-support rollers 206. The support frame assembly 210 provides the basic structure of the sled assembly 200 and includes opposite ends defining a front-to-rear axis A (FIG. 2B). The one or more guides 204 attach to the support frame assembly 210 and extend downwardly therefrom to maintain the position of the settling tank scraper 20 on wall 250 as it is moved.

As shown in FIG. 2A, the guides 204 extend below the top of wall 250. In further embodiments, one or more guides 204 may be configured to move along a track, groove, or some other mechanism to support the proper movement of the tank scraper 20.

The rollers 206 attach to the sled assembly and provide for a smooth movement along the wall 250. In one embodiment, the rollers 206 connect to the guides 204. In further embodiments, the rollers may connect directly to the frame assembly 210 or other roller supporting structures. The rollers 206 may be made of plastic, metal, or other suitable materials or combination of materials. The rollers 206 may be solid or hollow. In a hollow roller embodiment, the roller may include a sealable opening to allow for filling the roller with water or other substance to increase the weight of the roller while in use. The rollers rotate about respective horizontal axes oriented perpendicular to axis A.

The embodiment shown in FIG. 2A is designed to ride along the top of a pre-existing center wall. However, further embodiments are envisioned in which the sled assembly 200 and the center wall 250 are specifically adapted for use of the tank scraper. For example, a track may be attached to the top of the center wall 250 providing a mating surface for the sled assembly 200, which may use rollers as shown in FIG. 2A, a sled, or other rolling or sliding mechanisms, for example.

One or more scraper blade assemblies 230 is connected to the sled assembly 200 at a pivot point 220. Each assembly 230 includes a scraper blade 231 extending downwardly from a respective side of the sled assembly 200. A tensioning device, such as a tension spring 232, is attached to both blade assemblies 230 to bias bottom scraping ends 231a of the blades 231 toward one another, i.e., toward a vertical center plane B of the sled assembly 200, and thus ensure proper contact with the surface of the wall 250.

Alternatively, the blades 231 could be angled sharply toward the center plane B to firmly engage the wall by inherent elasticity of the blade, and/or separate springs could be provided for the respective blades. In the embodiment shown in FIG. 2A, the scraper blade assembly 230 includes an attachment end with a bend and an attachment hole to allow the scraper blade assembly 230 to attach to the sled assembly.

FIG. 2B shows a top view of a settling tank scraper, according to an embodiment of the present invention. As shown in FIG. 2B, the support frame assembly includes side members 212A and 212B, front support member 214, rear support member 216, and center support member 218. Various attachment points 224 may also be configured for attaching a towing device 222, such as a rope, cable, chain, or other mechanism for pulling the support frame assembly. In a further embodiment, a second towing device 223 may be attached to the rear of the sled assembly for maintaining stability of the frame assembly while it is pulled with towing device 222, as well as for pulling the sled assembly to return the tank scraper to its starting position. The sled may also be pulled in one direction for a first scraping pass and pulled in the opposite direction when a second scraping pass is necessary. The towing devices 222 and 223 may be pulled manually or mechanically with a winch or other device, e.g., motor-driven. Rollers 206A and 206B, as shown in FIG. 2B, are mounted with axles 207A and 207B.

The scraping end 248 is sufficiently flexible to enable the lower portion of the blade 249 to somewhat flatten out and engage flush against the wall when pulled against the wall. Only a slight amount of flexing is necessary since the height H of the band of material to be scraped is relatively short, e.g., about 1-4 inches, or closer to 2 inches.

Alternatively, the blade could be formed with a lower end that is bent so as to engage flush with the wall.

FIG. 2C shows a detailed view of scraper blade assemblies attached to a center support member for a settling tank scraper, according to an embodiment of the present invention. In FIG. 2C, each scraper blade assembly 230A and 230B is attached to center support member 218 with support rod 219 through pivot point 220 to pivot about an axis coinciding with the front-to-rear axis A. A bushing 233 is placed within pivot point 220 to provide a wear surface between the center support member 218 and the support rod 219. Each blade assembly 230A and 230B is then attached in a similar manner with a first washer 234 between the center support member 218 and the blade assembly 230A and 230B. The first washer 234 facilitates the movement of the blade assembly as it is tensioned against the tank wall. A second washer 235, an adjustment nut 236, and a locknut 237 are then used to secure the blade to the support rod. The adjustment nut 236 and locknut 237 are adjusted to allow movement of the blade assembly 230A and 230B. In further embodiments, multiple pivot points 220 may be provided in the center support member 218 to allow each blade assembly to be independently attached.

FIG. 2D shows a blade assembly for a settling tank scraper, according to an embodiment of the present invention. As described above, the blade assembly 230 includes an attachment end 241 and a scraping end 248. In the embodiment shown in FIG. 2D, the attachment end 241 includes a bend 242 of approximately 45 degrees, an attachment flange 244, and a support flange 246. The attachment flange provide additional strength and stiffness to the top of the attachment end 241 and further includes an attachment point 245 through which a support rod is passed. The attachment end 241 also includes a support flange 246 for increased strength and stiffness along the length of the blade assembly 230. In one embodiment, the scraping end 248 includes a double edged scraper blade 249 (see FIG. 2G showing the two scraping edges 249a) allowing the tank scraper to scrape a tank wall while being pulled in either direction along the wall. A tensioning spring 232 is also shown connected to the attachment end of the blade assembly 230. The scraping end 248 is sufficiently flexible to enable the lower portion of the blade 249 to somewhat flatten-out and engage flush against the wall when pulled against the wall. Only a slight amount of flexing is necessary since the height H of the band of material to be scraped is relatively short, e.g., about 1-4 inches, or closer to 2 inches.

Alternatively, the blade could be formed with a lower end that is bent so as to engage flush with the wall.

In a further embodiment, a scraper blade assembly 230 may be configured with a separate attachment end 241 and a separate scraper end 248. In such an embodiment, the attachment end is configured to attach to a pivot point of the sled assembly and the blade end 248 attaches to the attachment end 241. According to one embodiment, the attachment end 241 and the blade end 248 may be configured to slide together for ease of blade replacement. In further embodiments, the blade end 248 may be attached with bolts, rivets, or other connecting devices 251 (FIG. 2H). Such embodiments provide the ability to quickly change a blade that is worn or damaged without disconnecting the entire blade assembly from the sled assembly. Such embodiments may also include additional holes 253 (see FIG. 2H) to provide the ability to adjust the elevation at which the scraping end contacts the tank wall to accommodate differing water levels or scraping procedures.

FIG. 2E shows a side view of a settling tank scraper, according to an embodiment of the present invention. In FIG. 2E, the tank scraper is shown in relation to a tank wall 250. In the embodiment shown, guides 204 are attached to a support frame assembly 210 and provide an attachment point for the rollers 206A and 206B. As shown in FIG. 2E, the guides 204 extend below the top of tank wall 250 for stabilizing the tank scraper as it is pulled along the tank wall 250. Scraper assemblies 230A and 230B are also shown extending below the top of tank wall 250 to reach build-up collected on the side of tank wall 250.

FIG. 2F shows a detailed view of the roller and axle configuration for a settling tank scraper, according to an embodiment of the present invention. Roller 206 is mounted to guides 204 with an axle 207 and a series of washers 260, axle nuts 262, adjustment nuts 264, locknuts 266 and a cotter pin 268.

As a further alternative, the blades 249 could be pivotably mounted to a common sled at locations corresponding to the end of the lead line for numeral 242 in FIG. 2D. The pivot axis for each blade would be horizontal and in the direction of sled travel.

While various examples have been provided, it will be apparent to those skilled in the art that various modifications and variations can be made in the present invention without departing from the spirit or scope of the invention. Thus, it is intended that the present invention cover the modifications and variations of this invention provided that they come within the scope of any claims and their equivalents.

What is claimed is:

1. Apparatus for scraping a wall of a settling tank, comprising:
a mobile carrier having opposite ends defining a front-to-rear axis of the carrier, the carrier configured to travel along the top of a wall of a settling tank, and
a scraper blade carried by the carrier and projecting downwardly from one side of the carrier,
wherein a bottom portion of the blade includes a scraping edge facing in a travel direction of the carrier and having a height dimensioned to scrape a band of built-up solids from a surface of the wall.

2. Apparatus according to claim 1, wherein the blade is biased toward a vertical center plane of the carrier to firmly engage the wall being scraped.

3. Apparatus according to claim 2, further including a biasing device is provided for urging the bottom portion of the blade toward the vertical center plane.

4. Apparatus according to claim 3 wherein the biasing device comprises a spring.

5. Apparatus according to claim 4, wherein the spring is connected to the carrier and arranged to exert a bias against the blade.

6. Apparatus according to claim 5, wherein the scraper blade is mounted to the carrier by a pivot defining a pivot axis extending coincident or parallel to a front-to-rear direction of the carrier.

7. Apparatus according to claim 1, wherein the scraper blade is adjustable to vary the elevation of the scraping end.

8. Apparatus according to claim 6, wherein the spring is a tension spring.

9. Apparatus according to claim 1 further including floor supports mounted on the carrier and rotatable about respective axes oriented perpendicular to a front-to-rear direction of the carrier.

10. Apparatus according to claim 1 further including a guide extending downwardly from said side of the carrier for guiding the carrier as it moves along the wall.

11. Apparatus according to claim 4, wherein the scraper blade constitutes a first scraper blade; the apparatus further including a second scraper blade carried by the carrier and extending downwardly from a second side of the carrier.

12. Apparatus for scraping a divider wall of a settling tank, comprising:
a mobile carrier having opposite ends defining a front-to-rear axis of the carrier, the carrier configured to travel along the top of a divider wall of a settling tank; and
first and second scraper blades carried by the carrier and extending downwardly from respective sides of the carrier;
wherein the bottom portions of the first and second scraper blades are biased toward one another during a wall-scraping operation in order to firmly engage respective opposite surfaces of the divider wall for scraping respective bands of built-up solids from such surfaces.

13. Apparatus according to claim 12 further including a spring arrangement for biasing the bottom ends of the first and second scraper blades toward one another.

14. Apparatus according to claim 13 wherein the spring arrangement comprises a tension spring interconnecting the first and second blades.

15. Apparatus according to claim 12 wherein the first and second blades are mounted to the carrier for pivoting movement about respective axis arranged coincident with, or parallel to, the front-to-rear axis.

16. Apparatus according to claim 12 further including a floor support mounted to the carrier and rotatable about an axis oriented perpendicular to the front-to-rear axis.

17. Apparatus according to claim 12 further including guides extending downwardly from the respective sides of the carrier for guiding movement of the carrier along the wall.

18. A method for scraping a wall of a settling tank comprising the steps of:
A. moving a carrier along a top of the wall; and
B. causing the bottom portion of a scraper blade carried by, and extending downwardly from, the carrier to engage a surface of the wall to scrape a band of built-up solids from the surface.

19. The method according to claim 18 further including the step of spring-biasing the bottom portion of the blade against the surface.

20. The method according to claim 18, wherein step B comprises causing respective bottom portions of first and second scraper blades carried by, and extending downwardly from, the carrier to engage respective opposite surfaces of the wall to scrape respective bands of built-up solids therefrom.
